(19) United States
(12) Patent Application Publication
(10) Pub. No.: US 2015/0378935 A1
(43) Pub. Date: Dec. 31, 2015

(54) STORAGE TABLE REPLACEMENT METHOD

(71) Applicant: SHANGHAI XINHAO MICROELECTRONICS CO. LTD., Shanghai (CN)

(72) Inventor: KENNETH CHENGHAO LIN, Shanghai (CN)

(21) Appl. No.: 14/766,754

(22) PCT Filed: Jan. 29, 2014
(86) PCT No.: PCT/CN2014/071812

§ 371 Date: Aug. 9, 2015

(30) Foreign Application Priority Data
Feb. 8, 2013 (CN) 201310050837.2

(51) Int. Cl. G06F 12/12; G06F 17/30

(52) U.S. Cl. CPC G06F 12/121; G06F 17/30339; G06F 17/30958; G06F 17/30321; G06F 2212/69

(57) ABSTRACT

A storage table replacement method uses an index table, a storage table containing multiple rows of storage cells, and a correlation table. The method includes storing information in one or more rows of storage cells in the storage table; and storing track addresses of the storage cells in the storage table in the index table. Every track address includes a row address and a column address. The method further includes recording, in every row in the correlation table, a total number of index rows/index table memory cells that use the row as an index target in the index table and addresses of a certain number of index rows/index table memory cells, where the correlation table and the storage table have a same number of rows; and, when a row of new information is generated, based on the correlation table, selecting and replacing a row in the storage table.

### CROSS-REFERENCES TO RELATED APPLICATIONS

This application claims priority of Chinese Patent Application No. 201310050837.2, filed on Feb. 8, 2013, the entire contents of which are incorporated by reference herein.

### FIELD OF THE INVENTION

The present invention generally relates to the fields of integrated circuit and computers and, more particularly, to methods for storage table replacement.

### BACKGROUND

In order to maintain high speed operation of the processor, cache is used in current technology. The cache is a high-speed information exchange storage device. Because the cache can exchange information with a central processing unit (CPU) earlier than a main memory, so the access speed of the cache is faster than the main memory. The caching principle often is: when the CPU needs to access information presumed to exist in the storage, it first checks the cache. If the requested information is found in the cache (cache hit), the request can be served by simply reading the cache, and the information is sent to the CPU, which is comparatively faster; if the requested information is not found in the cache (cache miss), the data has to be fetched from a memory with a comparatively slower speed and then the data is sent to the CPU. At the same time, the information block containing the information is written into the cache. Therefore, the information block can be read from the cache in the future, and the information does not need to be fetched from the memory. Such read mechanism allows the CPU to keep a very high cache hit rate when reading continuous information.

There can be a problem with the read mechanism, which is not limited to the above read mechanism. In the memory device (including but not limited to the cache), there is a process of information replacement. Because a memory device has a limited storage capacity (that is, the storage capacity is a specific limited value), when the memory device is full or the storage space to store the needed information is greater than remaining storage capacity of storage device, the storage space to store the needed information overlaps a part of information that is stored in the storage device. That is, part of information stored in the storage device needs to be deleted to release an amount of storage space to store the needed information.

The disclosed storage table replacement methods are directed to solve one or more problems set forth above and other problems.

### BRIEF SUMMARY OF THE DISCLOSURE

The present invention discloses a storage table replacement method using an index table, a storage table containing multiple rows of storage cells, and a correlation table to improve utilization efficiency of the storage table.

The storage table replacement method includes storing information in one or more rows of storage cells in the storage table; storing, in the index table, track addresses of the storage cells in the storage table, wherein every track address includes a row address and a column address; recording, in every row in the correlation table, a total number of index rows that use the row as an index target in the index table and addresses of a certain number of index rows, wherein the correlation table and the storage table have a same number of rows; and when a row of new information is generated, based on a record in the correlation table, selecting and replacing a row in the storage table.

Optionally, selecting and replacing a row in the storage table based on a record in the correlation table includes: selecting and replacing a row that records 0 number of index rows.

Optionally, every row in the correlation table also records an address tag of the corresponding row in the storage table.

Optionally, selecting and replacing a row in the storage table based on a record in the correlation table further includes: selecting and replacing a row that records n number of index rows and the row addresses of all index rows in the correlation table, wherein n is an integer larger than 0.

Optionally, the storage table replacement method further includes, when the replacement is performed, replacing the track address corresponding to the index cell in the index row recorded by the index row to be replaced with the address tag.

Optionally, when every row in the correlation table is not enough to record all the row addresses of the index rows that use the row as an index target, a linked list is configured to record the row addresses of the index rows as a supplementary to the correlation table.

The present invention also discloses another storage table replacement method using an index table, a storage table containing multiple rows of storage cells, and a correlation table. The storage table replacement method includes storing information in one or more rows of storage cells in the storage table; storing, in the index table, track addresses of the storage cells in the storage table, wherein every track address includes a row address and a column address; recording, in every row in the correlation table, a total number of index cells that use the row as an index target in the index table and cell addresses of a certain number of index cells, wherein the correlation table and the storage table have a same number of rows, and the cell address includes a row address and a column address; and when a row of new information is generated, based on a record in the correlation table, selecting and replacing a row in the storage table.

Optionally, wherein selecting and replacing a row in the storage table based on a record in the correlation table further includes: selecting and replacing a row that records 0 number of index cells.

Optionally, every row in the correlation table also records an address tag of the corresponding row in the storage table.

Optionally, selecting and replacing a row in the storage table based on a record in the correlation table further includes: selecting and replacing a row that records the cell addresses of all index cells in the correlation table.

Optionally, the storage table replacement method further includes: when the replacement is performed, replacing the track address of the index cell recorded by the row to be replaced with the address tag.

Optionally, when every row in the correlation table is not enough to record all the cell addresses of the index cells that use the row as an index target, a linked list is configured to record the cell addresses of the index cells as a supplementary to the correlation table.

The present disclosure includes a storage table replacement method. The storage table replacement method uses an index table, and storage table containing multiple rows of storage cells, and a correlation table. The method further includes recording, in every row in the correlation table, a total number of index rows/index table memory cells that use the row as an index target in the index table and addresses of a certain number of index rows/index table memory cells. The method also includes, when a row of new information is generated, based on a record in the correlation table, selecting and replacing a row in the storage table.

### BRIEF DESCRIPTION OF THE DRAWINGS

FIG. 1 illustrates a schematic diagram of an exemplary implementation for a storage table replacement method consistent with the disclosed embodiments;

FIG. 2 illustrates a schematic diagram of another exemplary implementation for a storage table replacement method consistent with the disclosed embodiments;

FIG. 3 illustrates a schematic diagram of another exemplary implementation for a storage table replacement method consistent with the disclosed embodiments; and

FIG. 4 illustrates a schematic diagram of another exemplary implementation for a storage table replacement method consistent with the disclosed embodiments.

### DETAILED DESCRIPTION

Reference will now be made in detail to exemplary embodiments of the invention, which are illustrated in the accompanying drawings. The same reference numbers may be used throughout the drawings to refer to the same or like parts.

To effectively replace information stored in the memory, a storage table replacement method is implemented by using an index table, a storage table, and a correlation table. The storage table includes multiple arrays of arranged storage cells, where every row of storage cells stores one row of information. An index cell in the index table stores a track address of the storage cell in the storage table. The track address includes a row address and a column address. The correlation table and the storage table have the same number of rows, where every row in the correlation table records the number of index rows that use the row as an index target in the index table and addresses of a certain number of index rows.

When a row of new information needs to be stored/recorded, based on the record in the correlation table, a row in the storage table is selected and replaced with the new information.

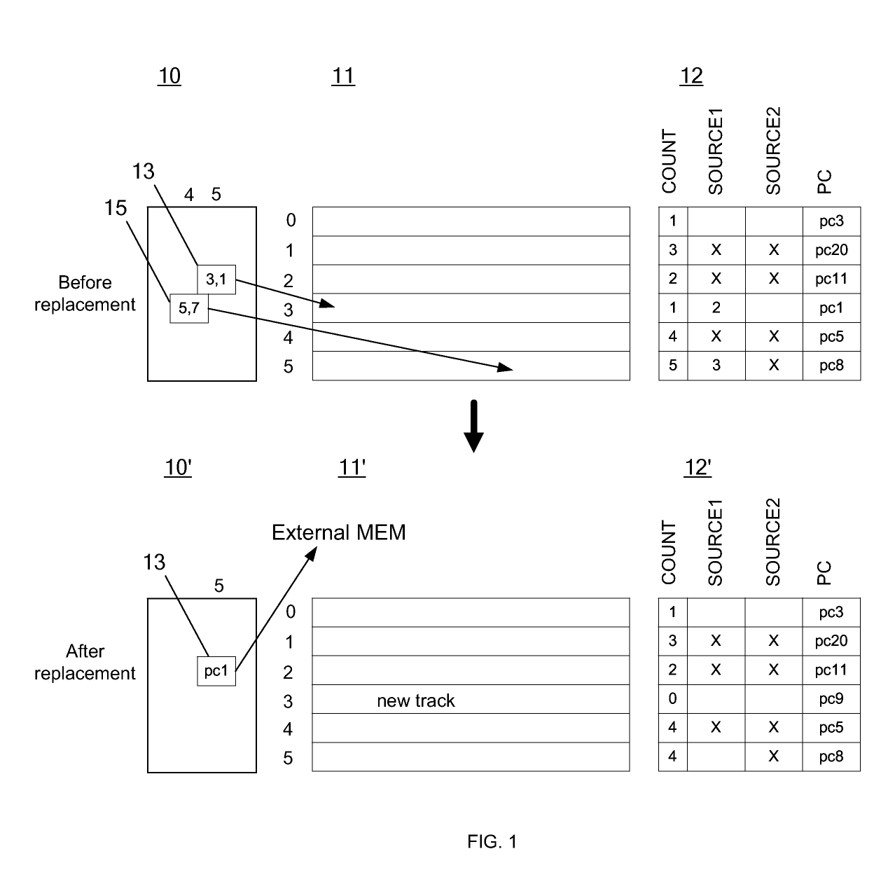

FIG. 1 illustrates a schematic diagram of an exemplary implementation for storage table replacement method consistent with the disclosed embodiments. As shown in FIG. 1, an index table 10, a storage table 11 and a correlation table 12 are used to implement the storage table replacement method. The index table 10, a storage table 11 and a correlation table 12 illustrate a storage state before the storage table replacement; and an index table 10′, a storage table 11′ and a correlation table 12′ illustrate a storage state after the storage table replacement.

The storage table 11 illustrates only 6 rows of storage cells, where the row address of each row in the storage table 11 is row address 0, row address 1, row address 2, row address 3, row address 4 and row address 5, respectively. That is, each row of storage cell is given a row address that is different from row addresses of other rows of storage cells in the storage table 11 at the same time. For illustration purposes, rows with row address 0, row address 1, row address 2, row address 3, row address 4 and row address 5 in the storage table 11 are called the 0th row, the 1st row, the 2nd row, the 3rd row, the 4th row, and the 5th row, respectively. The number of storage cells per row is not shown in FIG. 1, which can be one or more cells per row. There is no limitation for the number of storage cells in each row.

The correlation table 12 and the storage table 11 have the same number of rows. The correlation table 12 illustrates only 6 rows of storage cells, where row address of each row in the correlation table 12 and row address of each row in the storage table 11 are the same, i.e., having a one-to-one correspondence. That is, row addresses of rows in the correlation table 12 are row address 0, row address 1, row address 2, row address 3, row address 4 and row address 5, respectively. Similarly, for illustration purposes, rows with row address 0, row address 1, row address 2, row address 3, row address 4 and row address 5 in the correlation table 12 are called the 0th row, the 1st row, the 2nd row, the 3rd row, the 4th row, and the 5th row, respectively. Specifically, every row in the correlation table 12 records the number of index rows that use the particular row in the storage table 11 (that is, the row in the storage table 11 corresponds to the row in the correlation table 12, or the row whose row address in the storage table 11 is the same as the row address of the row in the correlation table 12) as an index target in the index table 10 and addresses of a certain number of index rows. A column of storage cells with a “COUNT” tag in the correlation table 12 (that is, every row in the correlation table 12 has a storage cell with “COUNT” tag) is used to store the total number of index rows using the particular row. Every row in the correlation table 12 has two columns that are used to record the row address of the index row (that is, every row in the correlation table 12 has two storage cells that are used to store/record the row address of the index row), which are labeled respectively by “SOURCE1” and “SOURCE2” tag. In other embodiments of this disclosure, the correlation table 12 can also use less or more columns to record a row address of an index row. For example, the correlation table 12 can use one column to record a row address of an index row. Or the correlation table 12 can also use three columns and four columns to record the row address of the index row.

When a row of new information needs to be stored/recorded, based on the record in the correlation table 12, a row in the storage table 11 is selected and replaced. For example, if the number of index rows recorded in the 0th row in the correlation table 12 is 0, the 0th row is selected and replaced. That is, information in the first row (‘0’) of the storage table 11 is replaced by new information. In other words, if a row in the correlation table 12 has 0 number of index rows, the row can be selected and replaced.

If the number of index rows recorded in every row in the correlation table 12 is not equal to 0, a row (in the storage table 11) which corresponds to a row with the number of index rows recorded not equal to 0 but equal to the number of valid index row addresses recorded in the correlation table 12 (that is, “COUNT” value equals to the number of “SOURCE1”, and “SOURCE2” that stores index row addresses) is selected and replaced. As shown in FIG. 1, for illustration purposes, “x” in the columns corresponding to “SOURCE1”, “SOURCE2” indicates that a valid index row address is recorded; blank indicates that corresponding “SOURCE1” and “SOURCE2” do not store a valid index row address.

In FIG. 1, the number of index rows recorded in the 0th row in the correlation table 12 is 1 but the index row address is not recorded in the 0th row; the number of index rows recorded in the 1st row is 3 and the 1st row records all index row addresses; the number of index rows recorded in the 2nd row is 2 and the 2nd row records all index row addresses; the number of index rows recorded in the 3rd row is 1 and the 3rd row records the corresponding index row address; the number of index rows recorded in the 4th row is 4 and the 4th row records all index row addresses; and the number of index rows recorded in the 5th row is 5. At this time, the number of index rows recorded in every row in the correlation table 12 is not equal to 0.

The contents of index cell 13 at the 2nd row and the 5th column of the index table 10 point to the 3rd row in the storage table 11. The number of index rows recorded in the 3rd row in the correlation table is 1, therefore only one index row (that is, the index row 2) points to the 3rd row in the storage table 11. Specifically, the index row points to the 3nd row and the 1st column of in the storage table 11. That is, the index row points to (3, 1) in the storage table 11. Therefore, the 3rd row in the correlation table 12 records the number of index rows “COUNT” as 1, row address “SOURCE1” of the index row as 2 (that is, the 2nd row or the 2nd index row in the index table 10).

At this time, when a row of new information needs to be stored/recorded, the 3rd row in the storage table 11 can be selected and replaced. Base on index row 2 recorded in “SOURCE1” of the 3rd row in the correlation table 12, an index cell that uses the 3rd row in the storage table 11 as an index target is searched in the 2nd row of the index table, and contents of the index cell (that is, the track address stored in the index cell) are updated. The track address of the track point corresponds to the instruction address of the instruction represented by the track point, thus reducing the risk of wrong pointing.

In contrast, although the number of index rows recorded in the 0th row in the correlation table 12 is also 1, because the 0th row does not record the row address of the corresponding index row, the 0th row in the storage table 11 cannot be selected and replaced.

Specifically, the correlation table 12 further includes a column with a “PC” tag. The column with the “PC” tag records an address tag of the corresponding row in the storage table 11. That is, every row in the correlation table 12 also records the address tag of the corresponding row in the storage table 11. The address tag refers to a tag that labels the corresponding row in the storage table 11. For example, an address that information stored in the rows in the storage table 11 locates at the other storage tables can be used as the address tag corresponding to the row. Thus, if information in the row in the storage table 11 is replaced, based on the address tag, the corresponding information can be found in other storage table, thus ensuring the index cell points to the right address.

In the storage table 11, an address of the 0th row is labeled as pc3; an address of the 1st row is labeled as pc20; an address of the 2nd row is labeled as pc11; an address of the 3rd row is labeled as pc1; an address of the 4th row is labeled as pc5; and an address of the 5th row is labeled as pc8. The address tag may be set based on needs, and there is no limitation for setting the address tag. The address tag only needs to label the address in the other storage table corresponding to the row in storage table 11.

The operations for replacing the row pointed to by the row address 3 in storage table 11 can further include the followings: when/after the 3rd row in the storage table 11 is replaced with new information (that is, when the storage table 11 is changed to a storage table 11′), based on row address 2 stored in “SOURCE1” in the correlation table 12, the 2nd row in the index table 10 is found. Then, a searching operation is performed on the 2nd row in the index table 10 and it is found that the track address stored in the 5th index cell points to the 3rd row in the storage table 11. Further, based on the address tag pc1 stored in the 3rd row in the correlation table 12, a track address (3, 1) stored in the 5th index cell of the 2nd row in the index table is changed to pc1, thus preventing the risk of the track address pointing to the wrong address.

When the 3rd row in the storage table 11 is replaced, the corresponding row in index table 10 also needs to be checked (that is, the 3rd row). Before the replacement, index cell 15 in the 3rd row and 4th column in the index table 10 stores track address (5, 7). That is, the index cell 15 points to a storage cell in the 5th row and 7th column in the storage table. Because the 3rd row in the storage table 11 is replaced, “COUNT” of the corresponding row (i.e. the 5th row) in the correlation table 12 is decreased by one. At the same time, “SOURCE1” that records the corresponding index row address (i.e., “3”) is found in the row, and the value in the “SOURCE1” is cleared. That is, “COUNT” of the 5th row in the correlation table 12 is changed to 4, and the value in the “SOURCE1” is set to blank.

After the above replacement, the index table 10 is changed to an index table 10′. That is, the track address (3, 1) stored in the index cell of 2nd row and 5th column in the index table is changed to pc1. The storage table 11 is changed to a storage table 11′. That is, the information stored in the 3rd row in the storage table is replaced and changed to new information (i.e., a new track). The correlation table 12 is changed to a correlation table 12′. That is, the contents stored in the 3rd row in the correlation table 12 are updated according to the updated information in the storage table 11′. At this time, it can be seen that the row pointed to by row address 3 in the storage table 11′ does not have the storage cell pointing because “COUNT” of row address 3 in the correlation table 12′ is 0. Then, based on the updated contents in the index table, the corresponding “COUNT” value in correlation table 12′ is updated. For example, when only 1 index row contains an index cell that points to the 3rd row in the storage table because of the updated contents of the index cell in the index table, “COUNT” of the row address 3 in the correlation table 12′ is changed to 1.

As can be seen from the above embodiments, the index cell in the index table 10 stores a track address of the storage cell in storage table 11. The track address includes a row address and a column address. The correlation table 12 and the storage table have the same number of rows, where every row in the correlation table 12 records the number of index rows and row addresses of a certain number of index rows when the row is used as an index target in the index table 10. Thus, when a row of new information needs to be stored/recorded, based on a record in the correlation table 12, a row in the storage table is selected and replaced, easily replacing information in the storage table 11 and improving use efficient of the storage table 11.

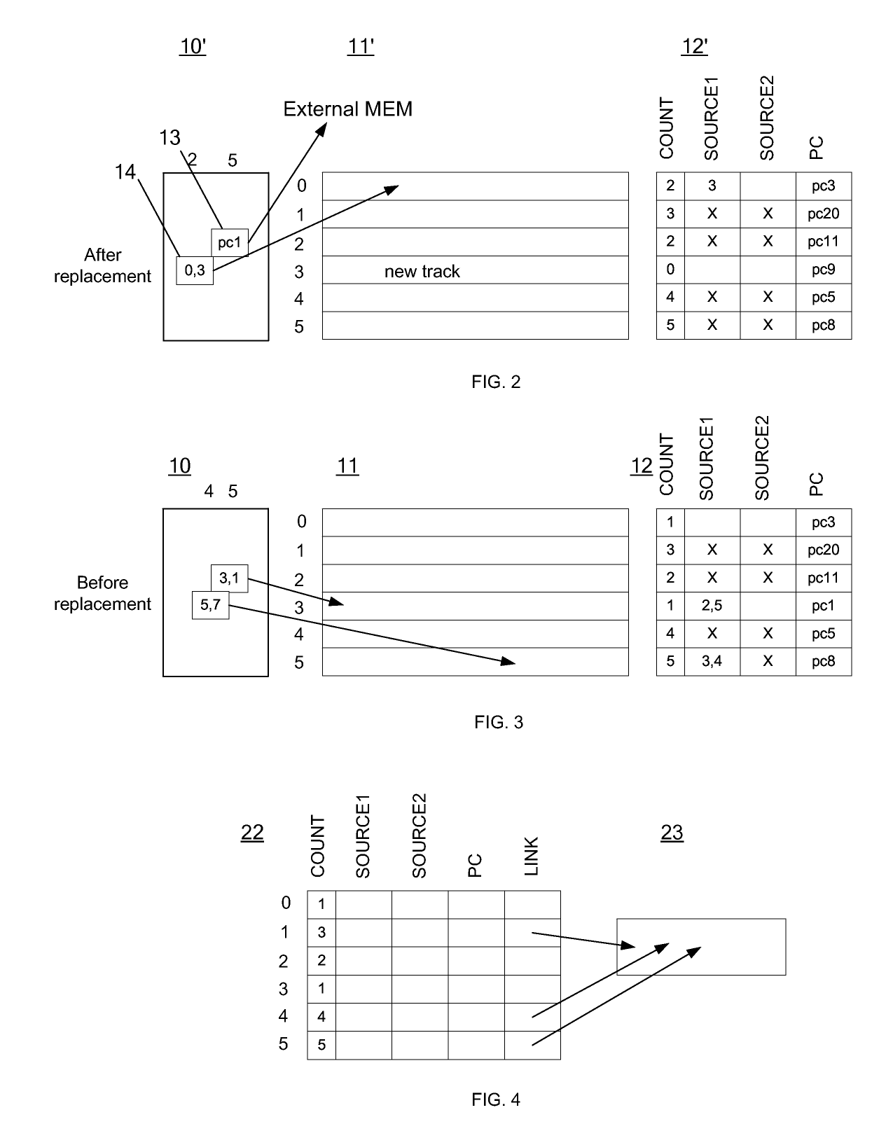

In addition, when a row of new information is stored/recorded in the storage table 11′, an index relationship between the new row of information and other row of information is established. FIG. 2 illustrates a schematic diagram of another exemplary implementation for a storage table replacement method consistent with the disclosed embodiments. As shown in FIG. 2, when new information is stored/recorded in the 3rd row in a storage table 11′, an index relationship that points to the 0th row information in the stored information is found, and the index relationship is recorded in the index table 10′. Therefore, an index target of an index cell 14 of the 3rd row and the 2nd column in an index table 10′ is a storage cell (0, 3) in the 0th row and 3rd column in the storage table 11′.

Therefore, the correlation table 12′ needs to be updated accordingly. Because the number of the index rows that use the 0th row in the storage table 11′ as an index target is increased, a “COUNT” value in the 0th row in the correlation table 12′ is increased by one. That is, the “COUNT” value is equal to ‘2’, and row address ‘3’ in the corresponding index row is stored in “SOURCE1”.

In addition, when the index relationship stored in the index table 10′ is changed due to any other reasons, the correlation table 12′ can be updated by the described above method, which is not repeated herein.

Every row in the correlation table 12 records the number of index rows that use the row as an index target in the index table 10 and addresses of a certain number of index rows in the embodiment in FIG. 1 and FIG. 2. In other embodiments of the disclosure, every row in the correlation table does not record the number of index rows that use the row as an index target in an index table and addresses of a certain number of index rows. However, every row in the correlation table records the number of index cells that use the row as an index target in the index table and cell addresses of a certain number of index cells. The cell address includes a row address and a column address.

FIG. 3 illustrates a schematic diagram of another exemplary implementation for a storage table replacement method consistent with the disclosed embodiments. As shown in FIG. 3, the storage table and the index table remain unchanged. That is, in the above example for replacing the contents of the 3rd row in the storage table 11, the index cell in the 2nd row and 5th column in the index table still stores the track address (3, 1) and points to the 3rd row in the storage table. Here, the contents recorded in a correlation table 12 needs to be changed. First, because there is only one storage cell that points to the 3rd row in the storage table, “COUNT” stored in the row pointed to by the row address 3 of the correlation table is still 1. However, the “SOURCE1” stored in the row is changed to (2, 5). That is, the “SOURCE1” records the cell address (2, 5) in the index table of the index cell that points to the 3rd row of the storage table.

After these changes, the original process “based on row address 2 stored in “SOURCE1” in the correlation table 12, the 2nd row in the index table 10 is found. Then, a searching operation is performed on the 2nd row in the index table 10 and it is found that the track address stored in the 5th index cell points to the 3rd row in the storage table 11. Further, based on the address tag pc1 stored in the 3rd row in the correlation table 12, a track address (3, 1) stored in the 5th index cell of the 2nd row in the index table is changed to pc1. “is also simplified. At this time, based on the cell address (2, 5) in the index table recorded in the correlation table, the stored information is found directly from the index table. That is, the 2nd row and 5th column in the index table is found. The track address (3, 1) stored in the cell in the 2nd row and 5th column in the index table is changed to pc1.

In addition, the replacement of the storage table may refer to the situation that the correlation table stores the row address of the index row. Based on a record in the correlation table, the process that a row in the storage table is selected and replaced includes: a row that records zero index cell is selected and replaced; every row in the correlation table also records an address tag of the corresponding row in the storage table. Based on a record in the correlation table, the process that a row in the storage table is selected and replaced also includes: a row that records more than zero index cell but the cell addresses of all index cells are recorded in the correlation table is selected and replaced; when the replacement is performed, the track address of the index cell recorded in the row to be replaced is replaced with the address tag.

A linked list is also provided based on the above embodiments. If a row address of an index row is stored in the correlation table, when every row in the correlation table is not enough to record all the row addresses of the index rows that use the row as an index target, the linked list is configured to record the row addresses of the index rows as a supplementary to correlation table; similarly, if a cell address of an index cell is stored in the correlation table, when every row in the correlation table is not enough to record all the index addresses of the index cells that use the row as an index target, the linked list is configured to record the cell addresses of the index cells as a supplementary to correlation table.

FIG. 4 illustrates a schematic diagram of another exemplary implementation for a storage table replacement method consistent with the disclosed embodiments. As shown in FIG. 4, the schematic diagram only illustrates a correlation table 22 and a linked list 23. The index table and storage table may refer to FIG. 1 or FIG. 3, which are not repeated herein. The linked list 23 is configured to record row addresses of the index rows or cell addresses of the index cells in the correlation table 22 as a supplementary to correlation table. Because the process of recording the row addresses of the index rows is the same as the process of recording the cell addresses of the index cells, only the process of recording the row addresses of the index rows is described in the embodiment shown in FIG. 4.

Referring to FIG. 4, the number of index rows recorded in the rows of correlation table 22 are the followings: “COUNT” of the 0th row is 1; “COUNT” of the 1st row is 3, “COUNT” of the 2nd row is 2, “COUNT” of the 3rd row is 1; “COUNT” of the 4th row is 4; and “COUNT” of the 5th row is 5. That is, the 0th row needs to record 1 row address; the 1st row needs to record 3row addresses; the 2nd row needs to record 2row addresses; the 3rd row needs to record 1row address; the 4th row needs to record 4row addresses; and the 5th row needs to record 5row addresses. Every row in the correlation table 22 has two storage cells that are used to store/record the row addresses of the index rows, which are labeled respectively by “SOURCE1” and “SOURCE2” tag (every row only has a certain number of storage cells that are used to record the row address to avoid wasting storage space). The correlation table 22 can also use one column to record a row address of an index row. Or the correlation table 22 can also use three columns and four columns to record the row address of the index row. The linked list 23 as a supplementary to the correlation table can record the row addresses recorded in the 1st row, the 4th row and the 5th row. That is, through the linked list 23, the 1st row can record all 3row addresses; the 4th row can record all 4row addresses; and the 5th row can record all 5row addresses.

After the correlation table 22 which is supplemented by the linked list 23 records all the row addresses of the index rows that use the row as an index target in the index table, every row in the storage table can be replaced, thus reducing the risk of wrong pointing.

The storage table replacement method uses an index table, a storage table containing multiple rows of storage cells, and a correlation table. The storage table stores information in one or more rows of storage cells. The index table stores track addresses of the storage cells in the storage table. Every track address includes a row address and a column address. Every row in the correlation table records a total number of index rows that use the row as an index target in the index table and addresses of a certain number of index rows, where the correlation table and the storage table have a same number of rows. When a row of new information is generated, based on a record in the correlation table, a row in the storage table is selected and replaced.

For example, in a multi-level cache hierarchy, a first level cache (L1 cache, i.e., highest level) is for latency and a last level cache (LLC) is for capacity. Before information blocks are requested, these information blocks are brought from lower level caches and/or memory by using the storage table replacement method. That is, the storage table replacement includes the policies that determine where to store the incoming information block and which information block to evict on a cache miss in the multi-level cache hierarchy. Thus, the storage table replacement can reduce the total cache misses and the time spent on accessing the next level memory. Therefore, a computer system achieves a better performance when the requested information block is cached in the L1 cache.

The disclosed methods may also be used in various processor-related applications, such as general processors, special-purpose processors, system-on-chip (SOC) applications, application specific IC (ASIC) applications, and other computing systems. For example, the disclosed devices and methods may be used in high performance processors to improve overall system efficiency.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

1. A storage table replacement method using an index table, a storage table containing multiple rows of storage cells, and a correlation table, comprising:
storing information in one or more rows of storage cells in the storage table;
storing, in the index table, track addresses of the storage cells in the storage table, wherein every track address includes a row address and a column address;
recording, in every row in the correlation table, a total number of index rows that use the row as an index target in the index table and addresses of a certain number of index rows, wherein the correlation table and the storage table have a same number of rows; and
when a row of new information is generated, based on a record in the correlation table, selecting and replacing a row in the storage table.

2. The method according to claim 1, wherein selecting and replacing a row in the storage table based on a record in the correlation table includes:
selecting and replacing a row that records 0 number of index rows.

3. The method according to claim 1, wherein:
every row in the correlation table also records an address tag of the corresponding row in the storage table.

4. The method according to claim 3, wherein selecting and replacing a row in the storage table based on a record in the correlation table further includes:
selecting and replacing a row that records n number of index rows and the row addresses of all index rows in the correlation table, wherein n is an integer larger than 0.

5. The method according to claim 4, further including:
when the replacement is performed, replacing the track address corresponding to the index cell in the index row recorded by the index row to be replaced with the address tag.

6. The method according to claim 5, wherein:
when every row in the correlation table is not enough to record all the row addresses of the index rows that use the row as an index target, a linked list is configured to record the row addresses of the index rows as a supplementary to the correlation table.

7. A storage table replacement method using an index table, a storage table containing multiple rows of storage cells, and a correlation table, comprising:
storing information in one or more rows of storage cells in the storage table;
storing, in the index table, track addresses of the storage cells in the storage table, wherein every track address includes a row address and a column address;
recording, in every row in the correlation table, a total number of index cells that use the row as an index target in the index table and cell addresses of a certain number of index cells, wherein the correlation table and the storage table have a same number of rows, and the cell address includes a row address and a column address; and
when a row of new information is generated, based on a record in the correlation table, selecting and replacing a row in the storage table.

8. The method according to claim 7, wherein selecting and replacing a row in the storage table based on a record in the correlation table includes:
selecting and replacing a row that records 0 number of index cells.

9. The method according to claim 7, wherein:
every row in the correlation table also records an address tag of the corresponding row in the storage table.

10. The method according to claim 9, wherein selecting and replacing a row in the storage table based on a record in the correlation table further includes:
selecting and replacing a row that records the cell addresses of all index cells in the correlation table.

11. The method according to claim 10, further including:
when the replacement is performed, replacing the track address of the index cell recorded by the row to be replaced with the address tag.

12. The method according to claim 11,
wherein:
when every row in the correlation table is not enough to record all the cell addresses of the index cells that use the row as an index target, a linked list is configured to record the cell addresses of the index cells as a supplementary to the correlation table.
